(19) United States
(12) Patent Application Publication
(10) Pub. No.: US 2025/0363586 A1
(43) Pub. Date: Nov. 27, 2025

(54) DECOMPOSITION OF WRITE MEMORY ACCESSES

(71) Applicant: QUALCOMM Incorporated, San Diego, CA (US)

(72) Inventors: Jeeva PAUDEL, San Jose, CA (US); Chunling HU, Campbell, CA (US)

(21) Appl. No.: 18/670,449

(22) Filed: May 21, 2024

(51) Int. Cl. G06T 1/60; G06F 8/40

(52) U.S. Cl. CPC G06T 1/60; G06F 8/40

(57) ABSTRACT

This disclosure provides systems, devices, apparatus, and methods, including computer programs encoded on storage media, for modifying a representation of source code. The representation of source code may include the source code or a transformed form of the source code (e.g., an intermediate representation (IR)). A processor configured to modify the representation of source code may obtain the representation of the source code. The processor may identify that the representation comprises a first set of decomposable write memory accesses. The processor may calculate a second set of slicing criteria based on the identified first set of decomposable write memory accesses. The processor may generate a plurality of representation slices based on the representation of the source code and the calculated second set of slicing criteria. The processor may output an indicator of the generated plurality of representation slices.

### TECHNICAL FIELD

The present disclosure relates generally to processing systems, and more particularly, to one or more techniques for analysis and processing of representations of source code.

### INTRODUCTION

Computing devices often compile source code to generate computer programs that perform functions, for example graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs may be configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may utilize the GPU during execution. A display processor may be configured to convert digital information received from a CPU to analog values and may issue commands to a display panel for displaying the visual content. A device that provides content for visual presentation on a display may utilize a CPU, a GPU, and/or a display processor.

GPUs may be designed for parallelism, and may lack the complexity of CPUs. For example, a GPU on a computing device may have less virtual memory addressing and paging than a CPU on the computing device. Current techniques may not address how control-flow divergence, memory divergence, and/or irregular workload distribution impede GPU utilization and productivity of high-performance program development. There is a need for improved analysis and modification of source code to solve challenges in debugging, program analysis, and performance tuning of programs generated using such source code.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a memory; and at least one processor coupled to the memory. The apparatus may be configured to modify a representation of a source code, for example raw source code or an intermediate representation (IR) of the source code. Based at least in part on information stored in the memory, the at least one processor may be configured to obtain the representation of the source code. The at least one processor may be configured to identify that the representation comprises a first set of decomposable write memory accesses. The at least one processor may be configured to calculate a second set of slicing criteria based on the identified first set of decomposable write memory accesses. The at least one processor may be configured to generate a plurality of representation slices based on the representation of the source code and the calculated second set of slicing criteria. The at least one processor may be configured to output an indicator of the generated plurality of representation slices.

In some aspects, the techniques described herein relate to a method of modifying a representation of a source code, including: obtaining the representation of the source code; identifying that the representation includes a first set of decomposable write memory accesses; calculating a second set of slicing criteria based on the identified first set of decomposable write memory accesses; generating a plurality of representation slices based on the representation of the source code and the calculated second set of slicing criteria; and outputting an indicator of the generated plurality of representation slices.

In some aspects, the techniques described herein relate to a method, where the representation includes at least one of the source code or a transformed form of the source code.

In some aspects, the techniques described herein relate to a method, where the first set of decomposable write memory accesses includes at least one of: a third set of uniform data accesses; a fourth set of divergent data accesses; or a fifth set of memory oversubscription buffer accesses that exceed a threshold value.

In some aspects, the techniques described herein relate to a method, where identifying that the representation includes the indicator of the first set of decomposable write memory accesses includes at least one of: identifying that each of the first set of decomposable write memory accesses satisfies a third set of type criteria; identifying that each of the first set of decomposable write memory accesses satisfies a fourth set of control flow (CF) criteria; identifying that each of the first set of decomposable write memory accesses satisfies a fifth set of data dependency criteria; or identifying whether an index set of the first set of decomposable write memory accesses is associated with a sixth set of predicates.

In some aspects, the techniques described herein relate to a method, where the third set of type criteria include at least one of: a statically known data type; a non-opaque data type; a statically bound pair of source operands and transitive dependencies; an aggregate type; a seventh set of sources including the aggregate type; an iterated access; an underlying object that exhausts an available hardware limit; a target that does not escape a corresponding shader stage until completion of the corresponding shader stage; or an eighth set of operands that consist of read-only variables or program state variables (PSVs) that do not escape the corresponding shader stage until completion of the corresponding shader stage.

In some aspects, the techniques described herein relate to a method, where the fourth set of CF criteria include at least one of: a seventh set of sources corresponding with a memory access of the first set of decomposable write memory accesses that are computed or are defined outside of irreducible regions; or an eighth set of sources that are computed or are defined outside of irreducible regions, where the seventh set of sources are transitively dependent on the eighth set of sources.

In some aspects, the techniques described herein relate to a method, where the fifth set of data dependency criteria include at least one of: a target that is not subsequently read by a first memory access in a corresponding shader stage; a seventh set of sources corresponding with a memory access of the first set of decomposable write memory accesses that are not used by a second memory access; an eighth set of sources that are not used by a second memory access, where the seventh set of sources are transitively dependent on the eighth set of sources; a ninth set of reads that are not self-referential; or a tenth set of writes that are not self-referential.

In some aspects, the techniques described herein relate to a method, where calculating the second set of slicing criteria includes: splitting an index set of a decomposable write memory access of the first set of decomposable write memory accesses based on the sixth set of predicates in response to the identification that the index set is associated with the sixth set of predicates.

In some aspects, the techniques described herein relate to a method, where calculating the second set of slicing criteria includes: splitting an index set of a decomposable write memory access of the first set of decomposable write memory accesses in response to an identification that the index set is not associated with any predicates.

In some aspects, the techniques described herein relate to a method, where splitting the index set of the decomposable write memory access includes: splitting the index set of the decomposable write memory access based on a resource size threshold.

In some aspects, the techniques described herein relate to a method, where outputting the indicator of the generated plurality of representation slices includes: outputting the indicator of the generated plurality of representation slices to a compiler.

In some aspects, the techniques described herein relate to a method, where outputting the indicator of the generated plurality of representation slices includes: scheduling each program slice of the generated plurality of representation slices for asynchronous launch relative to other representation slices of the generated plurality of representation slices.

In some aspects, the techniques described herein relate to a method, where outputting the indicator of the generated plurality of representation slices further includes: calculating a cost for an execution of the generated plurality of representation slices, where scheduling each program slice of the generated plurality of representation slices is in response to the calculated cost being greater than or equal to a threshold value.

In some aspects, the techniques described herein relate to a method, where outputting the indicator of the generated plurality of representation slices includes: calculating a cost for an execution of the generated plurality of representation slices; and outputting a second indicator of the calculated cost for the execution of the generated plurality of representation slices.

To the accomplishment of the foregoing and related ends, the one or more aspects include the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a block diagram that illustrates an example content generation system, in accordance with one or more techniques of this disclosure.

FIG. 2A illustrates an example of control-flow divergence, in accordance with one or more techniques of this disclosure.

FIG. 2B illustrates an example of memory divergence, in accordance with one or more techniques of this disclosure.

FIG. 2C illustrates an example of memory oversubscription, in accordance with one or more techniques of this disclosure.

FIG. 3 illustrates an example of a representation of source code having a plurality of write memory accesses, in accordance with one or more techniques of this disclosure.

FIG. 4 illustrates an example of a plurality of representations of source code based on the representation of FIG. 3, in accordance with one or more techniques of this disclosure.

FIG. 5 illustrates an example of a representation of source code having divergent memory accesses, in accordance with one or more techniques of this disclosure.

FIG. 6 illustrates an example of a representation of source code having a decomposable write memory access, in accordance with one or more techniques of this disclosure.

FIG. 7 illustrates an example of a plurality of representations of source code based on the representation of FIG. 5, in accordance with one or more techniques of this disclosure.

FIG. 8 is a workflow of an example method of generating slices, in accordance with one or more techniques of this disclosure.

FIG. 9 is a call flow diagram illustrating example communications between a compiler and a code representation modifier, in accordance with one or more techniques of this disclosure.

FIG. 10 is a call flow diagram illustrating example communications between an operating system and a compiler, in accordance with one or more techniques of this disclosure.

FIG. 11 is a flowchart of an example method of modifying a representation of source code in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, processing systems, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOCs), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

The term application may refer to software. As described herein, one or more techniques may refer to an application (e.g., software) being configured to perform one or more functions. In such examples, the application may be stored in a memory (e.g., on-chip memory of a processor, system memory, or any other memory). Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

In one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

As used herein, instances of the term “content” may refer to “graphical content,” an “image,” etc., regardless of whether the terms are used as an adjective, noun, or other parts of speech. In some examples, the term “graphical content,” as used herein, may refer to a content produced by one or more processes of a graphics processing pipeline. In further examples, the term “graphical content,” as used herein, may refer to a content produced by a processing unit configured to perform graphics processing. In still further examples, as used herein, the term “graphical content” may refer to a content produced by a graphics processing unit.

The following description is directed to examples for the purposes of describing innovative aspects of this disclosure. However, a person having ordinary skill in the art may recognize that the teachings herein may be applied in a multitude of ways. Some or all of the described examples may be implemented in any device or system that is capable of processing graphics commands. Various aspects relate generally to reprojecting and/or composing frames for a graphics processing unit (GPU). Some aspects more specifically relate to applying reprojection fallback strategies during an excess system load (e.g., when a reprojection process for a frame will not complete in time to display the frame). For example, a graphics system may have limited dynamic random access memory (DRAM) bandwidth due to concurrent work (e.g., rendering, GPU workload, high-intensity periods of camera data acquisition), software control latencies (e.g., poorly optimized code, latencies when communicating with third-party applications), bottlenecking hardware execution, and/or power/thermal throttling. Such loads may affect the calculated projected time for a reprojection process to complete within a threshold period of time. Use of remotely-rendered framebuffers (e.g., frames processed by a reprojection topology on a separate system, or a third-party system), may also affect the time to render a frame. For example, use of a second reprojection process may conserve resources if a first reprojection process uses remote-rendered framebuffers having a high calculated latency value, or if a first reprojection process uses a large amount of bandwidth (e.g., WiFi, 5G bandwidth) and a system is configured to conserve use of that bandwidth with respect to transmission/reception of remote-rendered frames.

In some examples, a code representation modifier (e.g., a processor, a compiler, or a compiler tool) may obtain a representation of a source code. A representation of source code may include raw source code or may include a transformed form of the source code. Raw source code may include source code entered into a compiler or a parser by a user. A transformed form of the source code may include an intermediate representation (IR) of the source code, such as high-level IR, a mid-level IR, or a low-level IR. The low-level IR may be a representation of source code generated by a compiler just before target-dependent code, or machine-dependent code. The code representation modifier may identify that the representation includes a first set of decomposable write memory accesses. A decomposable write memory access may include any write access command to a memory that may be decomposed into a plurality of write access commands that can execute independently without affecting one another. The code representation modifier may calculate a second set of slicing criteria based on the identified first set of decomposable write memory accesses. The slicing criteria may be criteria used by the code representation modifier to slice the representation of source code into a plurality of representation slices. The code representation modifier may generate a plurality of representation slices based on the representation of the source code and the calculated second set of slicing criteria. The code representation modifier may output an indicator of the generated plurality of representation slices. In some aspects, the code representation modifier may be a tool of a compiler, for example a tool that a compiler uses to determine if smaller, parallel slices of a representation of source code may be possible. In some aspects, the code representation modifier may be a component of a compiler, for example a stage of a compiler that allows the compiler to decompose a representation of source code into a plurality of representation slices for optimization and debugging of the representation of source code. When executed by a set of processors, the plurality of representation slices may perform the same function as the representation of source code. The set of processors may execute the plurality of representation slices synchronously or asynchronously. In other words, a representation slice of a representation of source code may be a version of a portion of the representation of source code, where the sum of all of the plurality of representation slices performs the same function as the single representation of source code. Each representation slice may affect a value at a specific point of interest, improving the ability of a programmer to identify and manage bugs in the program that affect the value.

Problem control-flow divergence, memory divergence, and/or irregular workload distribution may impede the performance and reliability of large, irregularly parallel shaders. Such issues may impede both effective GPU utilization, and the productivity of high-performance games development. Specializing shaders through slicing may be used to mitigate the impact of these issues. However, basic approaches to slicing yield ineffective max slices, or slices that are the same size as the original representation of source code. In some aspects, a type-based decomposition of iterated memory accesses for static slicing may be used to improve slicing techniques. A cost model that incorporates target specific microarchitectural details and the characteristics of shader slices may be used to determine selective decompositions. The cost model may improve both parallelism and locality of memory accesses while minimizing code bloat.

In some aspects, a shader may be prone to complex dependencies arising from interactions amongst a multitude of resources. For example, built-in variables, data of opaque types, implicitly and explicitly qualified input/output parameters, and a wide-range of address spaces for resource allocations may introduce complex dependencies that make it difficult to parse out whether a representation of source code can be separated into independent program slices. An opaque type may not be a real data value. An opaque type parameter may be a handle that may be passed as a function parameter. Precise context-sensitive dependence analysis may be time and memory prohibitive. In some aspects, an abundance of aggregates, such as arrays and records, may also elicit complex dependencies in shaders. A static analysis may treat each aggregate as a single scalar value to adapt algorithms intended for scalars to operate on aggregates. However, such an analysis may lead to highly imprecise program slices. A static analysis may decompose each aggregate into a collection of scalars to adapt algorithms intended for scalars to operate on aggregates. However, such an analysis may lead to highly precise, but a cost-prohibitive number of slices. A code representation modifier may use a series of slicing criteria to identify eligible accesses in order to accurately identify whether a representation of source code is able to be separated into independent program slices.

Particular aspects of the subject matter described in this disclosure can be implemented to realize one or more of the following potential advantages. In some examples, by reorganizing and separating divergent code and data accesses, and/or high resource-consuming data accesses from a single representation of source code into a plurality of independent representation slices that can be executed asynchronously and/or in parallel, the described techniques can be used to improve performance, streamline program analysis, and provide easier debugging of representations of source code.

The examples describe herein may refer to a use and functionality of a graphics processing unit (GPU). As used herein, a GPU can be any type of graphics processor, and a graphics processor can be any type of processor that is designed or configured to process graphics content. For example, a graphics processor or GPU can be a specialized electronic circuit that is designed for processing graphics content. As an additional example, a graphics processor or GPU can be a general purpose processor that is configured to process graphics content.

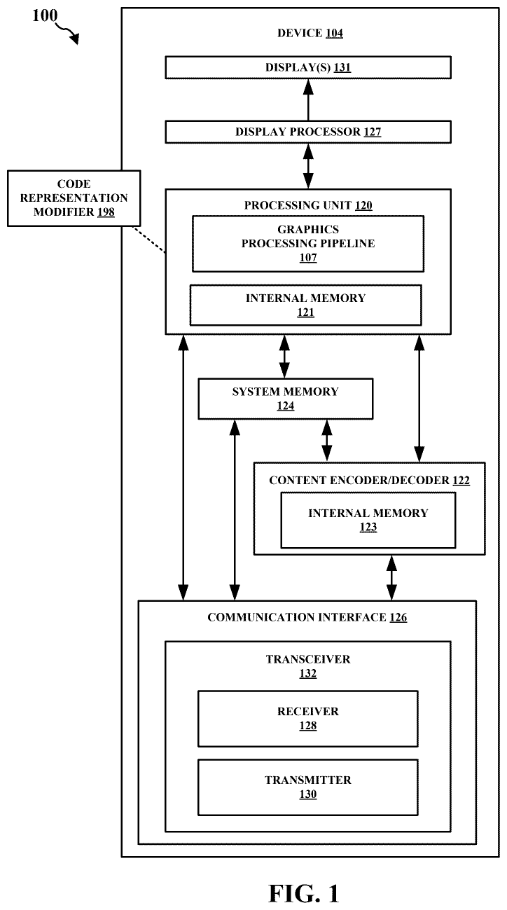

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of a SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components (e.g., a communication interface 126, a transceiver 132, a receiver 128, a transmitter 130, a display processor 127, and one or more displays 131). Display(s) 131 may refer to one or more displays 131. For example, the display 131 may include a single display or multiple displays, which may include a first display and a second display. The first display may be a left-eye display and the second display may be a right-eye display. In some examples, the first display and the second display may receive different frames for presentment thereon. In other examples, the first and second display may receive the same frames for presentment thereon. In further examples, the results of the graphics processing may not be displayed on the device, e.g., the first display and the second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing using a graphics processing pipeline 107. The content encoder/decoder 122 may include an internal memory 123. In some examples, the device 104 may include a processor, which may be configured to perform one or more display processing techniques on one or more frames generated by the processing unit 120 before the frames are displayed by the one or more displays 131. While the processor in the example content generation system 100 is configured as a display processor 127, it should be understood that the display processor 127 is one example of the processor and that other types of processors, controllers, etc., may be used as substitute for the display processor 127. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 may be communicatively coupled to the system memory 124 over a bus. In some examples, the processing unit 120 and the content encoder/decoder 122 may be communicatively coupled to the internal memory 121 over the bus or via a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, static random access memory (SRAM), dynamic random access memory (DRAM), erasable programmable ROM (EPROM), EEPROM, flash memory, a magnetic data media or an optical storage media, or any other type of memory. The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a CPU, a GPU, GPGPU, or any other processing unit that may be configured to perform graphics processing. In some examples, the processing unit 120 may be integrated into a motherboard of the device 104. In further examples, the processing unit 120 may be present on a graphics card that is installed in a port of the motherboard of the device 104, or may be otherwise incorporated within a peripheral device configured to interoperate with the device 104. The processing unit 120 may include one or more processors, such as one or more microprocessors, GPUs, ASICs, FPGAs, arithmetic logic units (ALUs), DSPs, discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, and/or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a code representation modifier 198 configured to obtain the representation of the source code. The code representation modifier 198 may identify that the representation comprises a first set of decomposable write memory accesses. The code representation modifier 198 may calculate a second set of slicing criteria based on the identified first set of decomposable write memory accesses. The code representation modifier 198 may generate a plurality of representation slices based on the representation of the source code and the calculated second set of slicing criteria. The code representation modifier 198 may output an indicator of the generated plurality of representation slices. The code representation modifier 198 may be a component of a compiler, or may be a tool utilized by a compiler that is configured to analyze and modify a representation of source code. Although the following description may be focused on compiler techniques, the concepts described herein may be applicable to other similar processing techniques.

A device, such as the device 104, may refer to any device, apparatus, or system configured to perform one or more techniques described herein. For example, a device may be a server, a base station, a user equipment, a client device, a station, an access point, a computer such as a personal computer, a desktop computer, a laptop computer, a tablet computer, a computer workstation, or a mainframe computer, an end product, an apparatus, a phone, a smart phone, a server, a video game platform or console, a handheld device such as a portable video game device or a personal digital assistant (PDA), a wearable computing device such as a smart watch, an augmented reality device, or a virtual reality device, a non-wearable device, a display or display device, a television, a television set-top box, an intermediate network device, a digital media player, a video streaming device, a content streaming device, an in-vehicle computer, any mobile device, any device configured to generate graphical content, or any device configured to perform one or more techniques described herein. Processes herein may be described as performed by a particular component (e.g., a GPU) but in other embodiments, may be performed using other components (e.g., a CPU) consistent with the disclosed embodiments.

A representation of source code may be configured to define a set of parallel shaders for a graphics processor, such as a GPU. In some aspects, a set of parallel shaders, for example a set of large, irregular parallel shaders, may experience control-flow divergence, memory divergence, and/or irregular workload distribution, which may impede both effective utilization of processors (e.g., GPUs) and productivity of high-performance program development. Large, irregular parallel shaders may also include challenges in debugging, program analyses, and performance tuning. It may be advantageous for a compiler tool, such as the code representation modifier 198, to split a representation of source code into a plurality of representation slices to improve the performance of execution of the program slices, or to improve use and maintenance of the program slices (e.g., improve readability, improve debugging). Splitting a representation of source code into parallel slices may also improve execution performance by GPUs, as a GPU may be designed to perform better at executing a plurality of short program slices in parallel than a long program slice that executes statements serially. For example, weaker memory models (e.g., a graphics memory model that defines when writes to a texture attached to a frame buffer object become visible to subsequent reads) may permit more concurrent behaviors, thus justifying hardware optimizations. Moreover, such memory models may enable additional compiler optimizations when executing program slices in parallel.

A representation of source code may include raw source code (e.g., source code input by a programmer user) or a transformed form of the raw source code (e.g., an IR of source code). A representation of source code may be referred to as a program slice. A representation of source code that has been split into a plurality of independent representations may be referred to as a plurality of program slices, or a plurality of representation slices. A program slice may include a set of statements and predicates that affect values computed at a statement. Such statements may be slicing criterion that may be used to slice a representation of source code into independent program slices. Program slices may be referred to as independent relative to one another where each of the independent program slices have discrete inputs and outputs relative to one another, and the variables in one program slice are not dependent upon any statements in any other program slice (i.e., a variable is not modified or changed by a statement in another program slice). A variable whose value differs for different threads in a wave may be referred to as a divergent variable. A variable whose value remains the same for different threads in a wave may be referred to as a uniform variable. For example, a thread identifier may be inherently divergent, as the variable is unique to a thread. A slicing criterion of a statement may be referred to as C<S, V>, where V represents the set of variables for a statement, and S represents the statement that computes values of the set of variables. A program slice may be computed by following control and data dependencies in a program dependence graph (PDG).

A program slice may read and write data through resources, for example by storing variable values to a memory and by loading variable values saved to a memory. Certain resources may have distinct layouts in memory. For example, a buffer resource type may have a memory layout that is distinct from a texture resource type. A buffer resource type may include a collection of raw data. A texture resource type may include a collection of revels (i.e., texture elements). A graphics shader program slice may be configured to create many resources, for example vertex buffers, index buffers, constant buffers, and textures. In some aspects, a resource may be strongly typed. In other aspects, a resource may be type less. For example, a program slice may create resources for a given size at compile time, and then declare the data type within the resource when the resource is bound to the pipeline.

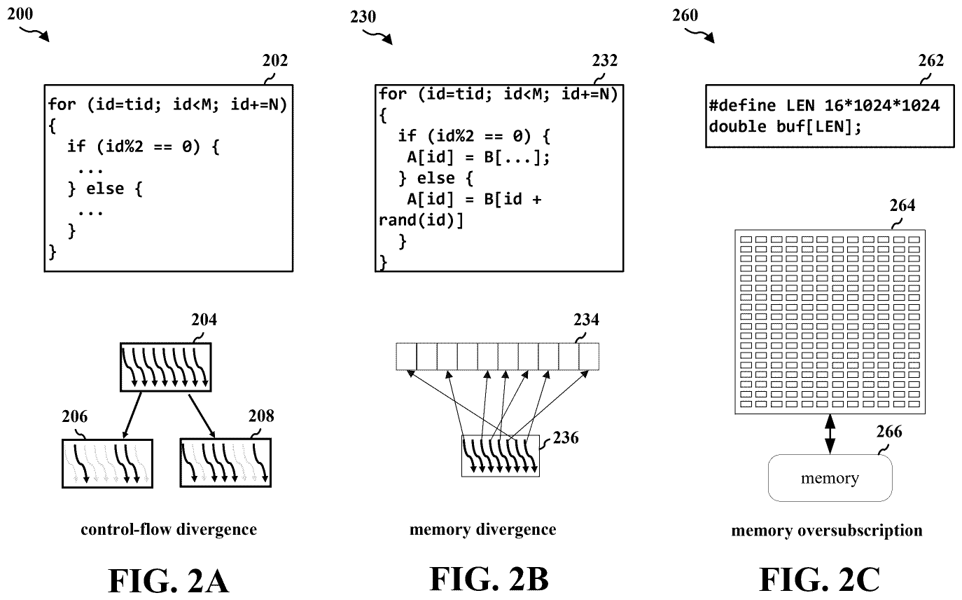

FIG. 2A is a diagram 200 of an example of control-flow divergence, in accordance with one or more techniques of this disclosure. A representation of source code 202 may include one or more branches. Such branches may be caused by a predicate, such as an if-else statement, and may be nested to generate a tree of branches. For example, a program includes a set of threads 204, where, for variables that satisfy a first criterion, the program executes the set of sub-threads 206 of the set of threads 204, and for variables that satisfy a second criterion, the program executes the set of sub-threads 208. Such control flow divergence may occur when threads in a wave follow different paths after processing the same branch.

In the representation of source code 202, the program may iterate through values of id between tid and M via increments of size N, may execute even-numbered values along the if path, and may execute odd-numbered values along the else path. In other words, a program with a set of threads 204 may have the set of sub-threads 206 representing threads along the if path, and the set of sub-threads 208 representing threads along the else path. As a result, the representation of source code 202 may be sliced into two independent program slices, one for iterated id values that are odd, and another for iterated id values that are even.

Where a representation of source code, such as the representation of source code 202, has a set of threads 204 that can be separated into two sets of independent sub-threads, such as the set of sub-threads 206 and the set of sub-threads 208, slicing the representation of source code 202 into independent slices may improve performance of executing the performance slices. This may be true for program slices executed on a GPU, as a GPU may be designed to execute short, parallel slices more efficiently than long, serial, or sequential, program slices. Slicing the representation of source code 202 into independent program slices may also improve readability, debugging, and overall maintenance of the program slices. Program slices may be referred to as independent where they have discrete inputs and outputs, and the variables in one program slice are not dependent upon any statements in any other program slice (i.e., a variable is not modified or changed by a statement in another program slice).

FIG. 2B is a diagram 230 of an example of memory divergence, in accordance with one or more techniques of this disclosure. A representation of source code 232 may include a load instruction, or a store instruction, which may access data-divergent addresses. Memory divergence may occur when a load or a store instruction accesses data-divergent addresses. For example, a representation of source code 232 may have a set of threads 236 which each access different addresses of the set of address locations 234.

In the representation of source code 232, the program may iterate through values of id between tid and M via increments of size N, may execute even-numbered values along the if path, and may odd-numbered values along the else path. Along the if path, the representation of source code 232 may retrieve variables from B[id], and along the else path, the representation of source code may retrieve variables from B[id+rand(id)]. As a result, the representation of source code 232 may be sliced into two independent program slices, one for iterated id values that are odd, and another for iterated id values that are even.

Data divergence may lead to either memory divergence, such as the example shown in FIG. 2A, control-flow divergence, such as the example shown in FIG. 2B, or both. Data divergence may be represented by composite data types, such as arrays and structures, which may group related data into one or more types using a single identifier. In the examples show in FIG. 2A and FIG. 2B, the identifier may be the variable id. Elements of composite data may be used discretely, or may be used as a single unit.

FIG. 2C is a diagram 260 of an example of memory oversubscription, in accordance with one or more techniques of this disclosure. A representation of source code may attempt to allocate more memory than a system can optimally handle, which may impact the performance of executing a program slice. For example, a definition 262 of a buffer for a GPU cache may be a buffer of type double having a size of 128 MB (e.g., a header having a “define LEN 16*1124*1124 double buf[LEN];” line may allocate 16×1124×1124 bits for an 8-byte double). The data 264 generated by a program slice may be stored and loaded from a memory 266, for example a GPU cache, defined by the definition 262. If a program slice tries to allocate resources that exceeds the allocated limit defined by the definition 262, the performance of the GPU may suffer load imbalance. For example, a program slice may be unable to load data as textures if a register file is not large enough to support a size of a variable. Some GPUs may lack virtual memory addressing or paging mechanisms that may be more common on CPU hosts. While some GPU drivers may page textures if the GPU runs out of memory, the performance of such GPU drivers may severely suffer with paging. In other words, some GPU drivers may enable a GPU program slice to use a large amount of memory than the physical memory available on the GPU via virtual memory addressing and/or paging mechanisms, but the performance of the GPU program slice may suffer, or the GPU program slice may even crash.

Slicing a program into smaller slices may solve memory oversubscription issues, as a smaller program slice may allocate less memory than a larger program slice. For example, a program slice that iterates through odd values of id between tid and M via increments of size N may be much smaller than a program slice that iterates through both odd values and event values of id.

A uniform data access may be a data access that is the same, or constant, from one data access to another. A divergent data access may be a data access that is different from one data access to another, for example control-flow or memory divergent data accesses. A memory oversubscription data access may be a data access that exceeds a size of an existing buffer or cache allocated to store the data. Such data accesses may result in paging, memory threshing, program hangs, GPU hangs, or other memory inefficiencies/errors.

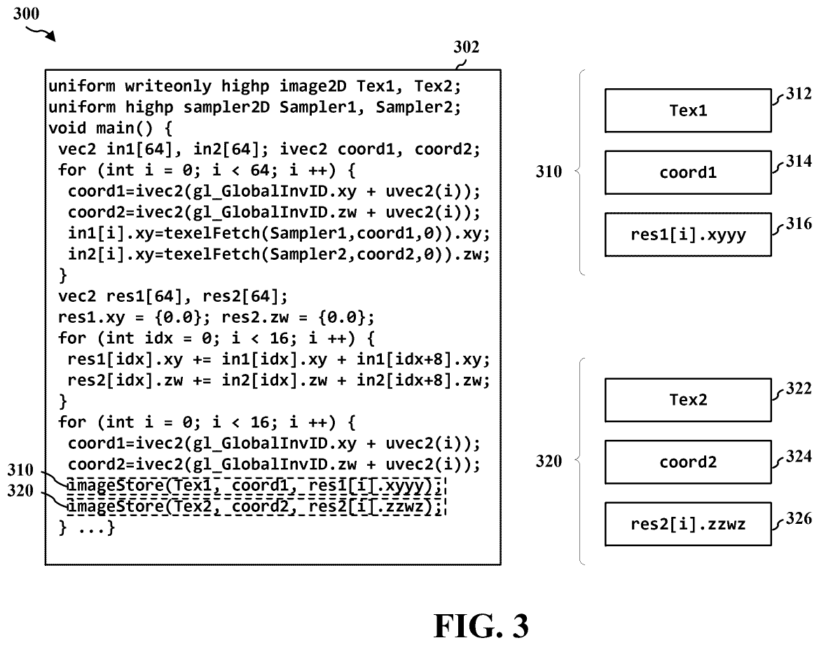

FIG. 3 is a diagram 300 of a representation of source code 302, which has a plurality of write memory accesses, shown here as write memory access 310 and write memory access 320. While the representation of source code 302 is shown as an open graphics library (OpenGL) shading language (GLSL) code, a code representation modifier may be configured to analyze a representation of source code written in any programming language, or an interpretation of any programming language.

Each write memory access is shown as a distinct texture update. A code representation modifier may reduce the size of the program represented by the representation of source code 302 by separating independent statements and their transitive dependencies. Specifically, the write memory access 310 accesses the variable 312, shown as Tex1, the variable 314, shown as coord1, and the variable 316, shown as res1[i].xyyy. The variable 316 may be an array that can be iterated through via a predicate, such as a “for” statement. The write memory access 310 may store a value into the variable 312, and may load values from the variable 314 and the variable 316. Similarly, the write memory access 320 accesses the variable 322, shown as Tex2, the variable 324, shown as coord2, and the variable 326, shown as res2[i].zzwz. The variable 326 may be an array that can be iterated through via a predicate, such as a “for” statement. The write memory access 320 may store a value into the variable 322, and may load values from the variable 324 and the variable 326. In some aspects, a code representation modifier may analyze the representation of source code 302 and generate a plurality of representation slices based on the representation of the source code. In other words, the write memory access 310 and the write memory access 320 may occur to independent textures, and the source operands of each image store may also be independent. The imageStore statements may update different images using independent textel coordinates and data computations. For example, the first statement “imageStore(Tex1, coord1, res1[i].xyyy)” may update the texture Tex1 at the coordinate coord1 using the values of res1 and the second statement “imageStore (Tex2, coord2, res2[i].zzwz)” may update the texture Tex2 at the coordinate coord2 using the values of res2. If the second statement were reading values at any coordinate positions in Tex1, the second statement may wait for the completion of the entirety of the first statement, which means the second statement would be dependent on the first statement. Thus, independent statements do not have overlapping memory accesses that have the potential to overwrite values used by the other statement before each independent statement has the opportunity to read a value for a memory access.

The code representation modifier may analyze the slicing criterion of each statement. For example, the code representation modifier may analyze the slicing criterion of the write memory access 310 as criterion C(S,V) or C (“imageStore (Tex1, coord1, res1[i].xyyy)”, res1). The code representation modifier may analyze parts of the representation of source code 302, such as the initialization of “res1.xy={0.0}” and the calculation of “res1[idx].xy+=in1[idx].xy+in1[idx+8].xy” in the for predicate. In other words, the code representation modifier may analyze parts of the representation of source code 302 that may affect the values at C (“imageStore (Tex1, coord1, res1[i].xyyy)”, res1), and use them to compute an independent program slice for the write memory access 310.

Similarly, the code representation modifier may analyze the slicing criterion of the write memory access 320 as criterion C (“imageStore (Tex2, coord2, res2[i].zzwz)”,res2). The code representation modifier may analyze parts of the representation of source code 302, such as the initialization of “res2.zw={0.0}” and the calculation of “res2[idx].zw+=in2 [idx].zw+in2 [idx+8].zw” in the for predicate. In other words, the code representation modifier may analyze parts of the representation of source code 302 that may affect the values at C (“imageStore (Tex2, coord2, res2[i].zzwz)”,res2), and use them to compute an independent program slice for the write memory access 320.

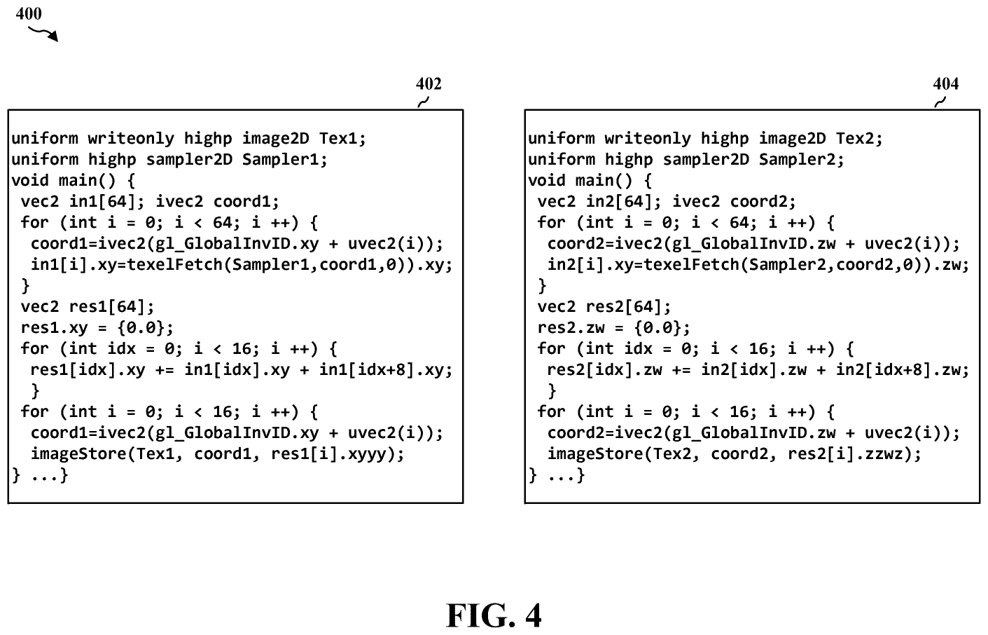

FIG. 4 is a diagram 400 of an example of a first representation slice 402 and a second representation slice 404 based on the representation of source code 302 in FIG. 3, in accordance with one or more techniques of this disclosure. The first representation slice 402 and the second representation slice 404 may be independent program slices relative to one another. That is, the two shader slices represented by the first representation slice 402 and the second representation slice 404 may be executed in parallel with one another, or serially with the first representation slice 402 executed after the second representation slice 404, or vice-versa, without the execution of the first representation slice 402 affecting the results of the execution of the second representation slice 404, or vice-versa. The write memory access represented by the first representation slice 402 and the write memory access represented by the second representation slice 404 may occur to independent textures, and the source operands of each image store may also be independent. In some aspects, a code representation modifier may be configured to leverage knowledge from a graphics domain to correctly identify independent image stores in representations of source code, such as the representation of source code 302 in FIG. 3, enabling slicing techniques of the code representation modifier to yield precise shader slices.

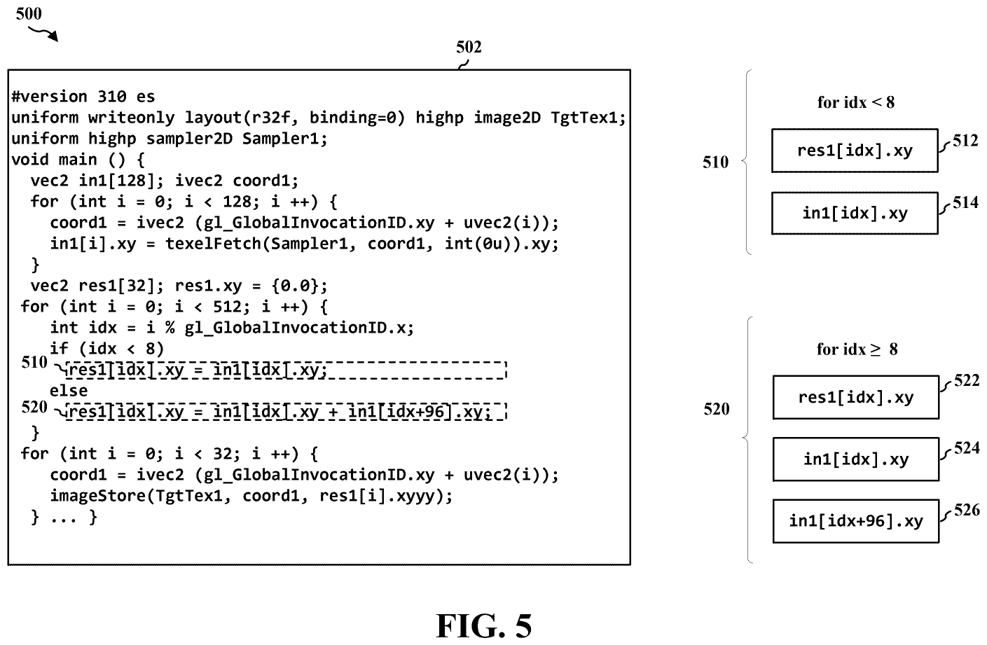

FIG. 5 is a diagram 500 of a representation of source code 502, which has divergent memory accesses, shown here as divergent memory access 510 and divergent memory access 520. Each memory accesses may be defined by an if/else predicate. In other words, the statement “res1[idx].xy=in1[idx].xy” may be predicated at indices of res1 less than 8, and the statement “res1[idx].xy=in1[idx].xy+in1[idx+96].xy” may be predicated at indices of res1 greater or equal to 8. In other words, res1 itself may be predicated at indices of less than 8 and greater or equal to 8, respectively. A code representation modifier may reduce the size of the program represented by the representation of source code 502 by separating the independent statements of the divergent memory access 510 and the divergent memory access 520 and their transitive dependencies. Specifically, the divergent memory access 510 accesses the variable 512, shown as res1[idx].xy, and the variable 514, shown as in1[idx].xy, for values of idx that are less than 8. The variable 512 and the variable 514 may be arrays that can be iterated through via a predicate, such as a “for” statement. The divergent memory access 520 accesses the variable 522, shown as res1[idx].xy, the variable 524, shown as in1[idx].xy, and the variable 526, shown as in1[idx+96].xy, for values of idx that are greater than or equal to 8. The variable 522, the variable 524, and the variable 526 may be arrays that can be iterated through via a predicate, such as a “for” statement.

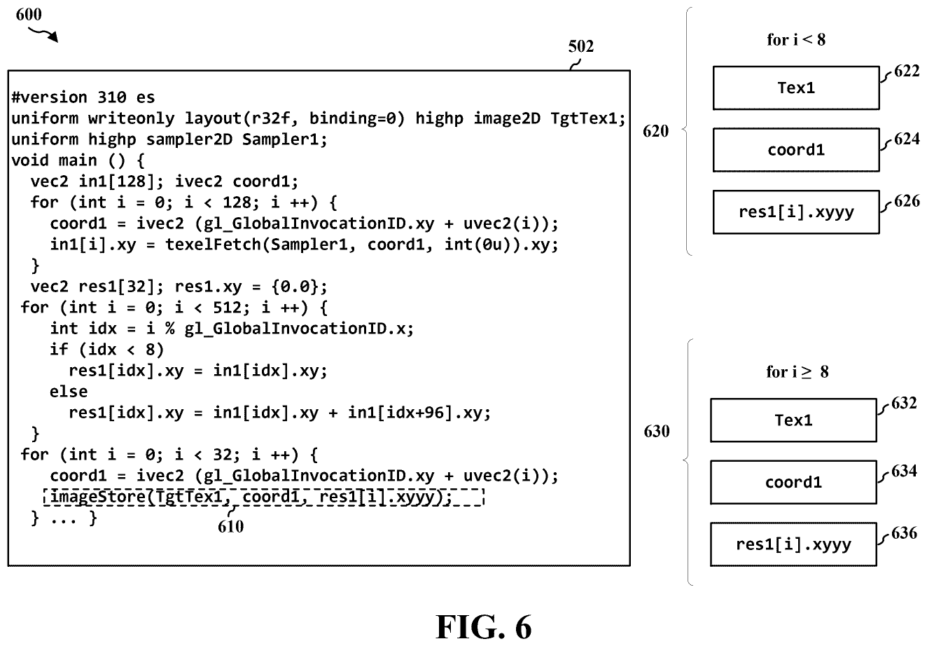

FIG. 6 is a diagram 600 of the representation of source code 502 from FIG. 5, which has a decomposable write memory access 610, in accordance with one or more techniques of this disclosure. The statement “imageStore (TgtTex1, coord1, res1[i].xyyy)” may be predicated at indices of res1 less than 8, and be predicated at indices of res1 greater or equal to 8. Specifically, the decomposable write memory access 610 may be represented by a first write memory access 620 that access the variable 622, shown as Tex1, the variable 624, shown as coord1, and the variable 626, shown as res1[i].xyyy, for values of i that are less than 8. The decomposable write memory access 610 may also be represented by a second write memory access 630 that access the variable 632, shown as Tex1, the variable 634, shown as coord1, and the variable 636, shown as res1[i].xyyy, for values of i that are greater or equal to 8.

In some aspects, a code representation modifier may analyze the representation of source code 502 and generate a plurality of representation slices based on the variable res1 that is predicated at indices less than 8.

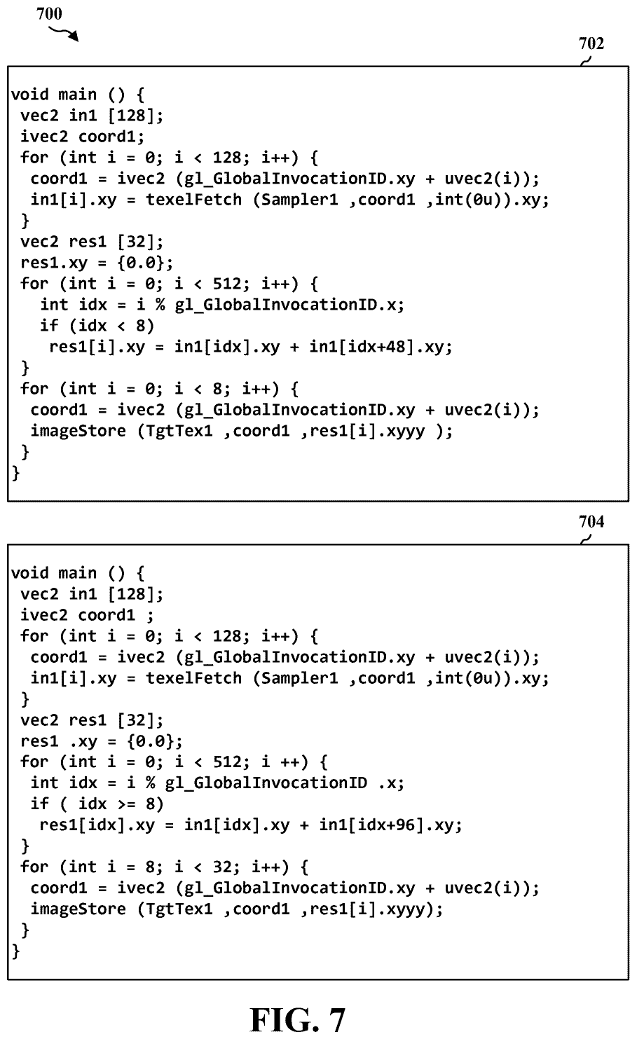

FIG. 7 is a diagram 700 of an example of a first representation slice 702 and a second representation slice 704 based on the representation of source code 502 in FIGS. 5-6, in accordance with one or more techniques of this disclosure. The first representation slice 702 and the second representation slice 704 may be independent program slices relative to one another. That is, the two shader slices represented by the first representation slice 702 and the second representation slice 704 may be executed in parallel with one another, or serially with the first representation slice 702 executed after the second representation slice 704, or vice-versa, without the execution of the first representation slice 702 affecting the results of the execution of the second representation slice 704, or vice-versa. The write memory access represented by the first representation slice 702 and the write memory access represented by the second representation slice 704 may occur to independent textures, and the source operands of each image store may also be independent. In some aspects, a code representation modifier may be configured to leverage knowledge from a graphics domain to correctly identify independent image stores in representations of source code, such as the representation of source code 502 in FIGS. 5-6, enabling slicing techniques of the code representation modifier to yield precise shader slices. Since the divergence arises from the predicate idx<32, a code representation modifier may identify the predicate as a splitting predicate for the slicing criteria. In other words, the code representation modifier may use the slicing criterion C [symbol] 18, res1ᵢ|i<32 [symbol] and C [symbol] 18, res1ᵢ|i≥32 [symbol] to yield two independent slices of shaders as shown in diagram 700. The first representation slice 702 and the second representation slice 704 of the representation of source code 502 may include a simplified control flow, smaller memory allocations, fewer memory transactions, and better locality of accesses.

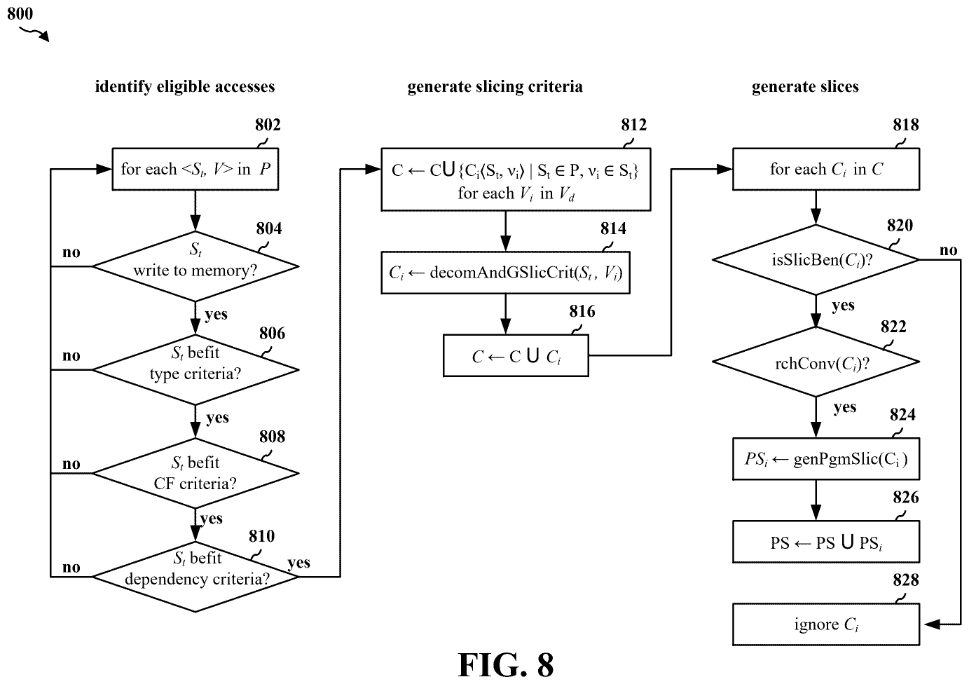

FIG. 8 is a diagram 800 of a workflow of an example method of generating slices. A code representation modifier, such as the code representation modifier 198 in FIG. 1, may utilize such a workflow to determine how and whether to slice a representation of source code into a plurality of representation slices. The workflow may first identify eligible access, that is, decomposable write memory accesses, generate slicing criteria for the eligible accesses, and then generate program slices based on the generated slicing criteria. The workflow may obtain a representation of the source code. Based on the representation, the workflow may generate a PDG and/or a set of write memory accesses (e.g., statements that update memory or textures). Such a workflow may decompose composite data as a systematic approach to mitigate the performance impact of control-flow divergence (e.g., FIG. 2A), memory divergence (e.g., FIG. 2B) and/or memory oversubscription (e.g., FIG. 2C), in parallel applications. In other words, the workflow may receive as input a representation of source code (e.g., program P), and may generate as output a set of independently executable slices (e.g., independent slices of P) that performs the same function as the representation of source code. In some aspects, the generated program slices may be analyzed using a cost model that improves parallelism and/or the locality of memory accesses while minimizing code bloat. Such cost models may incorporate target specific micro-architectural details.

The code representation modifier may analyze each statement (e.g., <Sₜ,V>) in a representation of source code (e.g., program P) to determine whether or not the statement is a decomposable write memory access. A decomposable write memory access is a statement that stores a variable in memory in such a way that the statement may be split into a plurality of independent program slices. A code representation modifier may deem a statement to be potentially decomposable if the statement performs write memory accesses with a specific set of attributes. The set of attributes may include a set of type criteria, a set of control flow (CF) criteria, a set of data dependency criteria, and/or whether an index set of a write memory access is associated with a predicate. An index set may be an indexed set of variables that are iteratively accessed.

At 802, the code representation modifier may analyze each individual statement (e.g., <Sₜ,V>) in a representation of source code (e.g., program P). The analysis of each statement may be independent from the analysis of other statements of the representation of source code.

Shaders may include data of different type, scope, storage, and visibility. Data dependence may occur when two memory references access the same memory location in the data space. The code representation modifier may focus on memory accesses whose dependencies are tractable with fast static dependence analysis.

At 804, the code representation modifier may determine whether the statement being analyzed, represented as Sₜ, is an eligible write to memory. The code representation modifier may determine whether the statement matches an eligible write memory access. For example, the code representation modifier may determine whether the statement includes (a) a write to a raw buffer, (b) a write to a structured buffer, (c) a store to an image, or (d) a texture update.

The determination at 804 may be represented by the high-level algorithm shown below, where Sₜ represents a statement in a program P:

```
writesMemory(Sₜ) → bool
  if isRawBufferWrite(Sₜ) then
    return TRUE
  else if isStructuredBufferWrite(Sₜ) then
    return TRUE
  else if isImageStore(Sₜ) then
    return TRUE
else if isTexture Update(Sₜ) then
    return TRUE
  else
    return FALSE
```

The input may be a statement Sₜ of the program P. The output may a determination of whether the statement is an eligible write statement.

The code representation modifier may determine that such memory write accesses are eligible for decomposition if and only if the memory write access fulfils type checks, control-flow checks, and dependence checks, as set forth below.

At 806, the code representation modifier may determine if a memory write befits a set of type criteria. The type criteria may include, for example, (a) if the type is statically known, (b) if the type is not opaque, (c) if the source operands of the statement and their transitive dependencies are statically bound, (d) if the write exhausts an available hardware limit (e.g., exceeds an memory threshold), (e) if one or more sources of the write exhausts an available hardware limit, (f), if the memory write does not escape a shader until completion of the current stage, (g), if the memory write involves an iterated access (e.g., a “for” statement), (h) if the memory write has an underlying object that exhausts an available hardware limit, (i), if the operands of the memory write are read-only variables input to the shader, or (j) if the operands of the memory write are program state variables (PSVs) that do not escape the shader. PSVs may be user-defined local variables that establish the context in which image and buffer updates occur. PSVs may be unavailable outside a program that performs the memory write.

The determination at 806 may be represented by the high-level algorithm shown below to determine if a memory access in a statement Sₜ fulfills type requirements:

```
befitsTypeCriteria(Sₜ) → bool
if isTypeStaticallyDeducible(Sₜ) then
  if not isOpaqueType(Sₜ) then
    for each v ∈ Sₜ do
      if escapesShader(Sₜ, v) then
        return FALSE
    bool hasAggr ← FALSE
    for each v ∈ Sₜ do
      hasAggr | = isAggregateAccess(Sₜ, v)
    if hasAggr then
      if opndsStaticallyBound(Sₜ) then
        if readOpndsArePSV(Sₜ) then
          return TRUE
return FALSE
```

The input may be a statement Sₜ of the program P. The output may a determination of whether the statement satisfies type requirements.

The determination at 806 may also identify decomposable aggregates. A high-level algorithm shown below may be used to identify decomposable aggregates for a variable v in a statement Sₜ:

```
collectDecomposable Vars(Sₜ, v) → bool
v_{d} ← Ø
for each vᵢ ∈ v do
  if isAggregateTy(vᵢ) then
    if isIteratedAccess(vᵢ) then
      if hasKnownAccessRange(vᵢ) then
        v_{d} ← v_{d} ∪ { vᵢ }
return v_{d}
```

The input may be a statement Sₜ of the program P. The output may a list of decomposable aggregates in the statement Sₜ.

At 808, the code representation modifier may determine if a memory write befits CF criteria. The CF criteria may include, for example, if the sources of the write and their transitively dependent sources are computed, or if the sources of the write and their transitively dependent sources are defined outside irreducible regions. In other words, the code representation modifier may determine that a memory write befits CF criteria if the sources of the write and their transitively dependent sources are either computed or are defined outside irreducible regions. Since some compiler analysis may be formulated for well-formed loops, the code representation modifier may preclude slicing in irreducible regions.

At 810, the code representation modifier may determine if a memory write befits dependency criteria. The dependency criteria may include, for example, (a) if the target of the memory write is not subsequently read by other memory accesses in the current shader stage, (b) if the memory write is the sole user of the source operands and all of their transitively dependent sources, and/or (c) if the memory write does not include self-referential reads and writes (e.g., a write to the underlying memory may be independent of any reads from the same memory object, neither in its entirety of composite form or its elementary form).

If the statement befits the set of attributes identified in the “identify eligible accesses” series of steps, then the code representation modifier may generate slicing criteria for the statement. In other words, in the “identify eligible accesses” section, the code representation modifier may check prerequisite criteria to determine whether a statement has sliceable memory accesses.

At 812, the code representation modifier may add to the list of criteria C, source criteria for each variable in the statement S. At 814, the code representation modifier may decompose and generate slicing criteria for each variable in the statement. At 816, the code representation modifier may add the slicing criteria to a set of criteria C.

The code representation modifier may identify precise slicing criteria for decomposing iteration space of eligible memory writes. The code representation modifier may employ index-set splitting to partition an index set of eligible memory writes. For example, an index set I=[0, 2n] may be split into two subsets of I₁=[0,n] and I₂=[n+1,2n], so long as the accesses fulfill type, control-flow, and data-dependence criteria (i.e., are eligible accesses). The code representation modifier may drive index set splitting by underlying patterns of iterated accesses, for example (a) monotonically increasing/decreasing iteration space at unit stride is partitioned in half, (b) iteration space enclosed in a binary predicate is split for each path arising from the predicate, (c) accesses defined by multiple binary predicates are split into n partitions for each predicate, and/or (d) predicates with statically unknown split points may devise dynamically resolvable predicates.

The system to generate slicing criteria at 814 may be represented by the high-level algorithm shown below for each eligible statement Sₜ with variables v:

```
decomposeAndGenSlicingCriteria(Sₜ, v)→∪ᵢ₌₁ⁿ Cᵢ [symbol]  Sₜ, vᵢ [symbol]
if inDivergentBlock(Sₜ, v) then
  {v₁, ..., vₙ} = splitIndexSet(Sₜ, v)
else
  {v₁, ... , vₙ} = partitionWorkload(Sₜ, v)
if Ø /= {v₁, ..., vₙ} then
  return ∪ᵢ₌₁ⁿ Cᵢ [symbol]  Sₜ, vᵢ [symbol]
else
  return Ø
```

The input may be a statement Sₜ of the program P with the variables vᵢ. The output may be the generated slicing criteria

Once the source criteria are generated, the code representation modifier may generate slices based on the representation of source code (e.g., program P). In some aspects, the code representation modifier may perform a cost analysis to determine if there is a net benefit to slicing the representation of source code based on the generated slicing criteria. At 818, the code representation modifier may decompose the representation of source code based on each criterion generated by the code representation modifier.

At 820, the code representation modifier may determine whether the slicing of the representation of source code into a plurality of representation slices was beneficial. For example, decomposition may increase code size. Decomposition may incur instruction cache misses. In some aspects, the code representation modifier may measure static code metrics based on a profitability model for slicing. The static code metrics may include negative metrics (e.g., memory spills, increased instruction count, increased texture accesses) that indicate the cost incurred by the net increase of that metric, and may include positive metrics (e.g., increase asynchronous launches, increased collocated memory accesses) that indicate potential benefits granted by the net increase of that metric. The metrics may be weighted, whose values may be calculated via an interplay between other compiler heuristics. In other words, the values of the weights may be target dependent, and/or may vary across compilers, hardware, and/or programming models.

For each slicing criterion, following the control and data-flow edges in a PDG may yield slices that include statements that are relevant to a selected index-set for a memory write. The code representation modifier may continue slicing until a cost model deems the resulting slices cost-prohibitive or until the slices are small enough to satisfy a programmer's goal of debugging or tuning. In other words, a cost model may halt the slicing, or a programmer instructing the code representation modifier to step through the algorithm and may instruct the code representation modifier to halt slicing when the programmer's subjective goal has been achieved. (e.g., a programmer may press a first key to instruct the code representation modifier to iterate through the slices, and may press a second key to instruct the code representation modifier to stop iterating through the slices).

A cost-driven slicing decision may be represented by the high-level algorithm shown below for each set of slices S_{c} of the statement Sₜ with variables v:

```
performCostDrivenSlicing(S_{c} [symbol]   Sₜ, v [symbol]   )
PS ← Ø
for each S_{ci} [symbol]   Sₜᵢ, vᵢ [symbol]   ∈ S_{c} [symbol]   Sₜ, v [symbol]   do
  PSᵢ ← createSlice(S_{ci})
  if not isSliceMaximal(PSᵢ) then
    if isSliceBeneficial(fxn, stats, PSᵢ) then
      PS ← PS ∪ PSᵢ
return PS
```

The input may be a set of slices S_{c} of the statement Sₜ with the variable v. The output may be the generated set of slices that are beneficial. A maximal slice is a program slice of 1, where the representation of the source code has not been sliced into a plurality of slices.

The code representation modifier may determine whether a slice is beneficial based on static code metrics, as decomposing iterated accesses to memory may improve program performance (e.g., improving parallelism, improving locality of accesses, reducing the length of divergent paths), but may increase code size and/or may incur instruction cache misses. Positive metrics may indicate potential benefits be a net increase in the metric, and negative metrics may indicate a cost incurred by a net increase in the metric. The code representation modifier may calculate weight parameters via an interplay between other compiler heuristics, and thus may be target dependent. In other words, weights may vary across compilers, hardware, and/or programming models. Such costs models may also account for runtime features, for example local and global work size and/or input/output size.

At 822, the code representation modifier may determine if the program slices have reached a convergence, or the sub-shaders no longer incur register spills. At 824, the code representation modifier may generate the program slices based on the representation of the source code. At 826, the code representation modifier may add the generated program slices to the plurality of program slices to execute.

At 828, if the code representation modifier determines that a proposed program slice based on generated slicing criteria is not beneficial, the code representation modifier may ignore the slicing criteria and may not use the slicing criteria to slice the representation of source code. Similarly, at 828, if the code representation modifier determines that a set of proposed program slices do not reach convergence, or incur register spills, the code representation modifier may ignore the slicing criteria and may not use the slicing criteria to slice the representation of source code.

Once a representation of source code has been sliced into a plurality of representation slices that are determined to be beneficial, the code representation modifier may output the plurality of representation slices. The plurality of representation slices may be compiled and scheduled for asynchronous launch, producing the same outputs as the original representation of source code would have, but with greater parallelism and less divergence. Users maintaining the source code may find it easier to comprehend, refactor, debug, analyze, trace, and discover security vulnerabilities when using the plurality of representation slices as the code is simpler and shorter than the original representation of source code. In short, overall program comprehension during software maintenance and evolution is improved, in addition to performance, when a code representation modifier slices a representation of source code into a plurality of representation slices that are determined to be beneficial at 820 and converge at 822.

The workflow shown in FIG. 8 may also be represented by the high-level algorithm shown below, where P represents a user program, Sₜ represents a statement in P, v represents a variable in Sₜ, and C represents a slicing criteria generated by a code representation modifier:

```
genSlicingCriteria(P) → {C [symbol]   Sₜ, v [symbol]   | Sₜ ∈ P, v ∈ Sₜ}
C ← Ø
for each Stin P do
  if writesMemory(Sₜ) then
    if befits TypeCriteria(Sₜ) then
      if befitsCFCriteria(Sₜ) then
        if befitsDataDepCriteria(Sₜ) then
          C∪{Cᵢ [symbol]   Sₜ, vᵢ [symbol]   | Sₜ ∈ P, vᵢ ∈ Sₜ}
        else
          v_{d} ← Ø
          v_{d} ← collectDecomposableVar(Sₜ)
          if not isEmpty(v_{d}) then
            for Each v_{di} in v_{d} do
              C ← C∪ decomposeAndGenSlicingCriteria(Sₜ, vdᵢ)
if C /= Ø then
  performSlicing(C)
```

The input may be the source code, or an intermediate representation of the program P. The output may be a plurality of independently executable slices of the program P, as explained above.

A code representation modifier may be used to slice representations of source code (e.g., kernels) to improve parallelism. Such splitting may be beneficial to (a) help reduce control-flow and memory divergence, (ii) help remove one or more barriers, (iii) help reduce register pressure in a compute bound kernel, and/or (iv) help reduce memory usage in a memory bound kernel. Such a code representation modifier may have a static component for splitting, and a runtime component for adapting execution to employ resulting sub-kernels. On a host machine, a code representation modifier may extend the compiler's ability to examine the given kernel's iteration-space of reads and writes. The iteration spaces may depend on thread IDs or on the values of other array elements in case of indirections, or on the values of scalar parameters of the kernels. The code representation modifier may transform kernels deemed worthy of splitting (e.g., eligible splits that have a positive calculated benefit) into sub-kernels where pertinent accesses include a fraction of the original kernel. The host may then enqueue the sub-kernels for asynchronous launch. During runtime, at each iteration, the host may compute each new partition of the parallel iteration space defined by each sub-kernel. Such code representation modifiers may analyze and transform a kernel for each invocation of the kernel and/or may memorize the binaries and reuse them in subsequent invocations.

A code representation modifier may be used to slice graphics shaders to avoid instruction cache overflows. Such code representation modifiers may split a graphics shader that exhibits high register pressure into multiple slices. For example, the code representation modifier may identify statements in the shader that write to memory or output variables. The code representation modifier may repeat slicing until convergence or the sub-shaders no longer incur register spills. Slicing may include (a) splitting an iteration space of the output, (b) identifying statements relevant to each partition of the split iteration space, and (c) creating shader slices for each split of the iteration space. The code representation modifier may launch such split shaders in parallel.

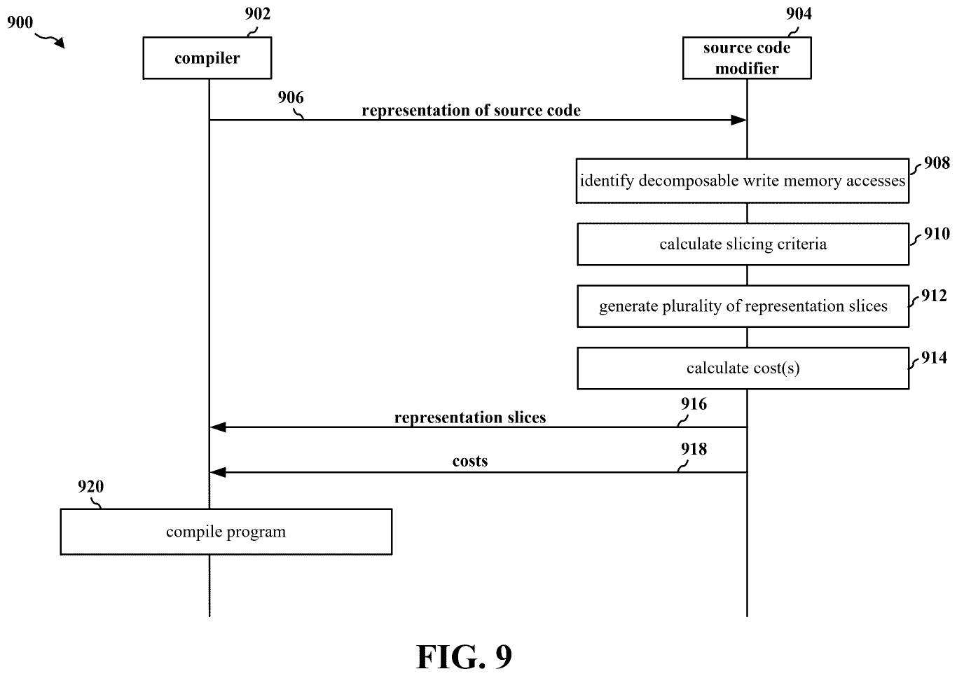

FIG. 9 is a call flow diagram 900 illustrating example communications between a compiler 902 and a code representation modifier 904 in accordance with one or more techniques of this disclosure. The compiler may transmit a representation of source code 906 to the code representation modifier 904. At 908, the code representation modifier 904 may identify decomposable write memory accesses. At 910, the code representation modifier 904 may calculate slicing criteria. At 912, the code representation modifier 904 may generate plurality of representation slices. At 914, the code representation modifier 904 may calculate the costs for each of the generated plurality of representation slices at 912. The code representation modifier 904 may transmit a set of representation slices 916 generated at 912 to the compiler 902. The code representation modifier 904 may transmit a set of costs 918 calculated at 914 to the compiler 902. At 920, the compiler may compile slices based on the set of representation slices 916 and the set of costs 918 received from the code representation modifier 904.

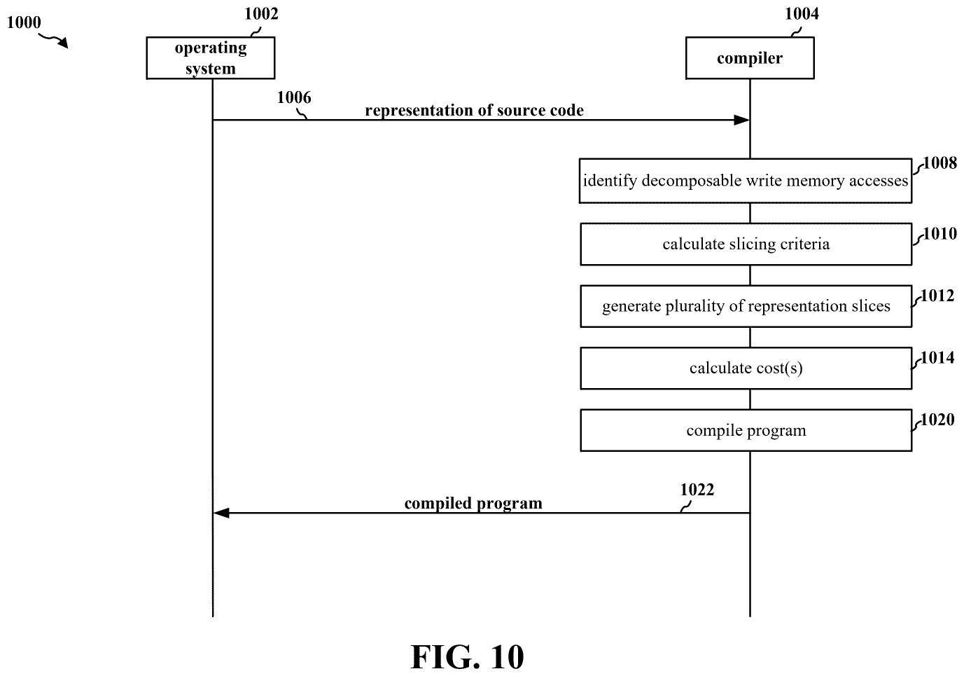

FIG. 10 is a call flow diagram 1000 illustrating example communications between an operating system 1002 and a compiler 1004 in accordance with one or more techniques of this disclosure. The operating system 1002 may transmit a representation of source code 1006 to the compiler 1004. At 1008, the compiler 1004 may identify decomposable write memory accesses. At 1010, the compiler 1004 may calculate slicing criteria. At 1012, the compiler 1004 may generate plurality of representation slices. At 1014, the compiler 1004 may calculate the cost for asynchronous parallel execution of the representation slices generated at 1012. At 1020, the compiler 1004 may compile the plurality of representation slices based on the calculated costs at 1014. The compiler 1004 may transmit the compiled program 1022 to the operating system 1002.

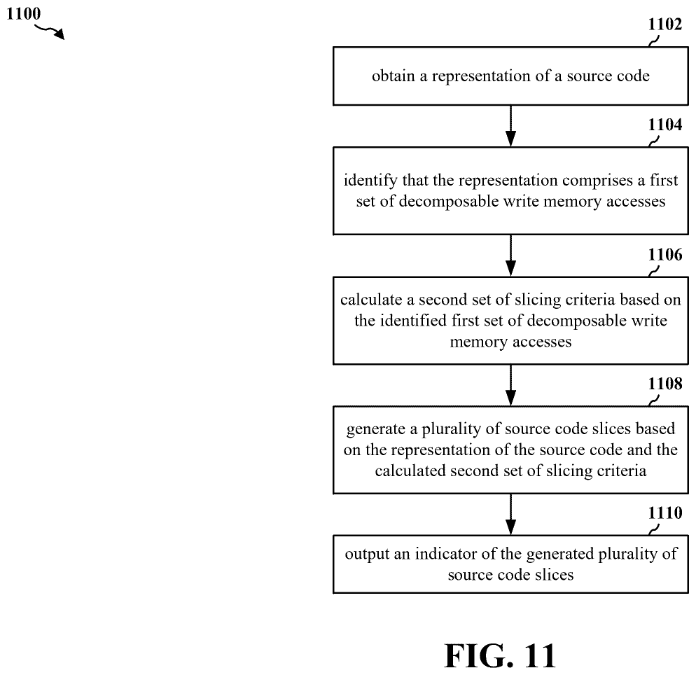

FIG. 11 is a flowchart 1100 of an example method of modifying a representation of a source code in accordance with one or more techniques of this disclosure. The method may be performed by an apparatus, such as an apparatus for compiling source code, a GPU, a CPU, a compiler, a compiler tool, a wireless communication device, and the like, as used in connection with the aspects of FIGS. 3-10.

At 1102, the apparatus may obtain a representation of a source code.

At 1104, the apparatus may identify that the representation comprises a first set of decomposable write memory accesses.

At 1106, the apparatus may calculate a second set of slicing criteria based on the identified first set of decomposable write memory accesses.

At 1108, the apparatus may generate a plurality of representation slices based on the representation of the source code and the calculated second set of slicing criteria.

At 1110, the apparatus may output an indicator of the generated plurality of representation slices.

In configurations, a method or an apparatus for graphics processing is provided. The apparatus may be a GPU, a CPU, or some other processor that may perform graphics processing. In aspects, the apparatus may be the processing unit 120 within the device 104, or may be some other hardware within the device 104 or another device. The apparatus may include means for obtaining the representation of the source code. The apparatus may further include means for identifying that the representation comprises a first set of decomposable write memory accesses. The apparatus may further include means for calculating a second set of slicing criteria based on the identified first set of decomposable write memory accesses. The apparatus may further include means for generating a plurality of representation slices based on the representation of the source code and the calculated second set of slicing criteria. The apparatus may further include means for outputting an indicator of the generated plurality of representation slices.

It is understood that the specific order or hierarchy of blocks/steps in the processes, flowcharts, and/or call flow diagrams disclosed herein is an illustration of example approaches. Based upon design preferences, it is understood that the specific order or hierarchy of the blocks/steps in the processes, flowcharts, and/or call flow diagrams may be rearranged. Further, some blocks/steps may be combined and/or omitted. Other blocks/steps may also be added. The accompanying method claims present elements of the various blocks/steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, where reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.” Unless stated otherwise, the phrase “a processor” may refer to “any of one or more processors” (e.g., one processor of one or more processors, a number (greater than one) of processors in the one or more processors, or all of the one or more processors) and the phrase “a memory” may refer to “any of one or more memories” (e.g., one memory of one or more memories, a number (greater than one) of memories in the one or more memories, or all of the one or more memories).

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

Computer-readable media may include computer data storage media or communication media including any medium that facilitates transfer of a computer program from one place to another. In this manner, computer-readable media generally may correspond to: (1) tangible computer-readable storage media, which is non-transitory; or (2) a communication medium such as a signal or carrier wave. Data storage media may be any available media that can be accessed by one or more computers or one or more processors to retrieve instructions, code, and/or data structures for implementation of the techniques described in this disclosure. By way of example, and not limitation, such computer-readable media may include RAM, ROM, EEPROM, compact disc-read only memory (CD-ROM), or other optical disk storage, magnetic disk storage, or other magnetic storage devices. Disk and disc, as used herein, includes compact disc (CD), laser disc, optical disc, digital versatile disc (DVD), floppy disk, and Blu-ray disc, where disks usually reproduce data magnetically, while discs usually reproduce data optically with lasers. Combinations of the above should also be included within the scope of computer-readable media. A computer program product may include a computer-readable medium.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing (e.g., modifying a representation of a source code), comprising: obtaining a representation of source code; identifying that the representation comprises a first set of decomposable write memory accesses; calculating a second set of slicing criteria based on the identified first set of decomposable write memory accesses; generating a plurality of representation slices based on the representation of the source code and the calculated second set of slicing criteria; and outputting an indicator of the generated plurality of representation slices.

Aspect 2 is the method of aspect 1, wherein the representation comprises at least one of the source code or a transformed form of the source code.

Aspect 3 is the method of either of aspects 1 or 2, wherein the first set of decomposable write memory accesses comprises at least one of: a third set of uniform data accesses; a fourth set of divergent data accesses; or a fifth set of memory oversubscription buffer accesses that exceed a threshold value.

Aspect 4 is the method of any of aspects 1 to 3, wherein identifying that the representation comprises the indicator of the first set of decomposable write memory accesses comprises at least one of: identifying that each of the first set of decomposable write memory accesses satisfies a third set of type criteria; identifying that each of the first set of decomposable write memory accesses satisfies a fourth set of control flow (CF) criteria; identifying that each of the first set of decomposable write memory accesses satisfies a fifth set of data dependency criteria; or identifying whether an index set of the first set of decomposable write memory accesses is associated with a sixth set of predicates.

Aspect 5 is the method of aspect 4, wherein the third set of type criteria comprise at least one of: a statically known data type; a non-opaque data type; a statically bound pair of source operands and transitive dependencies; an aggregate type; a seventh set of sources comprising the aggregate type; an iterated access; an underlying object that exhausts an available hardware limit; a target that does not escape a corresponding shader stage until completion of the corresponding shader stage; or an eighth set of operands that consist of read-only variables or program state variables (PSVs) that do not escape the corresponding shader stage until completion of the corresponding shader stage.

Aspect 6 is the method of either of aspects 4 or 5, wherein the fourth set of CF criteria comprise at least one of: a seventh set of sources corresponding with a memory access of the first set of decomposable write memory accesses that are computed or are defined outside of irreducible regions; or an eighth set of sources that are computed or are defined outside of irreducible regions, wherein the seventh set of sources are transitively dependent on the eighth set of sources.

Aspect 7 is the method of any of aspects 4 to 6, wherein the fifth set of data dependency criteria comprise at least one of: a target that is not subsequently read by a first memory access in a corresponding shader stage; a seventh set of sources corresponding with a memory access of the first set of decomposable write memory accesses that are not used by a second memory access; an eighth set of sources that are not used by a second memory access, wherein the seventh set of sources are transitively dependent on the eighth set of sources; a ninth set of reads that are not self-referential; or a tenth set of writes that are not self-referential.

Aspect 8 is the method of any of aspects 4 to 7, wherein calculating the second set of slicing criteria comprises: splitting an index set of a decomposable write memory access of the first set of decomposable write memory accesses based on the sixth set of predicates in response to the identification that the index set is associated with the sixth set of predicates.

Aspect 9 is the method of any of aspects 4 to 8, wherein calculating the second set of slicing criteria comprises: splitting an index set of a decomposable write memory access of the first set of decomposable write memory accesses in response to an identification that the index set is not associated with any predicates.

Aspect 10 is the method of aspect 9, wherein splitting the index set of the decomposable write memory access comprises: splitting the index set of the decomposable write memory access based on a resource size threshold. A resource size threshold may also be referred to as a hardware resource limit or an available memory. Thus, the index set may be split to ensure that the resultant representation slice does not exceed hardware resource limits, exceed available memory, or cross known resource thresholds that may impact performance.

Aspect 11 is the method of any of aspects 1 to 10, wherein outputting the indicator of the generated plurality of representation slices comprises: outputting the indicator of the generated plurality of representation slices to a compiler.

Aspect 12 is the method of any of aspects 1 to 11, wherein outputting the indicator of the generated plurality of representation slices comprises: scheduling each program slice of the generated plurality of representation slices for asynchronous launch relative to other representation slices of the generated plurality of representation slices.

Aspect 13 is the method of aspect 12, wherein outputting the indicator of the generated plurality of representation slices further comprises: calculating a cost for an execution of the generated plurality of representation slices, wherein scheduling each program slice of the generated plurality of representation slices is in response to the calculated cost being greater than or equal to a threshold value.

Aspect 14 is the method of any of aspects 1 to 13, wherein outputting the indicator of the generated plurality of representation slices comprises: calculating a cost for an execution of the generated plurality of representation slices; and outputting a second indicator of the calculated cost for the execution of the generated plurality of representation slices.

Aspect 15 is the method of any of aspects 1 to 13, wherein outputting the indicator of the generated plurality of representation slices comprises: transmitting the indicator of the generated plurality of representation slices; or storing the indicator of the generated plurality of representation slices.

Aspect 16 is an apparatus for modifying a representation of a source code, including at least one processor coupled to a memory and configured to implement a method as in any of aspects 1-15.

Aspect 17 is an apparatus for modifying a representation of a source code including means for implementing a method as in any of aspects 1-15.

Aspect 18 is a computer-readable medium (e.g., a non-transitory computer-readable medium) storing computer executable code, the code when executed by at least one processor causes the at least one processor to implement a method as in any of aspects 1-15.

Various aspects have been described herein. These and other aspects are within the scope of the following claims.

What is claimed is:

1. An apparatus for graphics processing, comprising:
a memory; and
a processor coupled to the memory, wherein, based at least in part on information stored in the memory, the processor is configured to:
obtain a representation of source code;
identify that the representation comprises a first set of decomposable write memory accesses;
calculate a second set of slicing criteria based on the identified first set of decomposable write memory accesses;
generate a plurality of representation slices based on the representation of the source code and the calculated second set of slicing criteria; and
output an indicator of the generated plurality of representation slices.

2. The apparatus of claim 1, wherein the representation comprises at least one of the source code or a transformed form of the source code.

3. The apparatus of claim 1, wherein the first set of decomposable write memory accesses comprises at least one of:
a third set of uniform data accesses;
a fourth set of divergent data accesses; or
a fifth set of memory oversubscription buffer accesses that exceed a threshold value.

4. The apparatus of claim 1, wherein, to identify that the representation comprises the indicator of the first set of decomposable write memory accesses, the processor is configured to:
identify that each of the first set of decomposable write memory accesses satisfies a third set of type criteria;
identify that each of the first set of decomposable write memory accesses satisfies a fourth set of control flow (CF) criteria;
identify that each of the first set of decomposable write memory accesses satisfies a fifth set of data dependency criteria; or
identify whether an index set of the first set of decomposable write memory accesses is associated with a sixth set of predicates.

5. The apparatus of claim 4, wherein the third set of type criteria comprise at least one of:
a statically known data type;
a statically bound pair of source operands and transitive dependencies;
an aggregate type;
a seventh set of sources comprising the aggregate type;
an iterated access;
an underlying object that exhausts an available hardware limit;
a target that does not escape a corresponding shader stage until completion of the corresponding shader stage; or
an eighth set of operands that consist of read-only variables or program state variables (PSVs) that do not escape the corresponding shader stage until the completion of the corresponding shader stage.

6. The apparatus of claim 4, wherein the fourth set of CF criteria comprise at least one of:
a seventh set of sources corresponding with a memory access of the first set of decomposable write memory accesses that are computed or are defined outside of irreducible regions; or
an eighth set of sources that are computed or are defined outside of the irreducible regions, wherein the seventh set of sources are transitively dependent on the eighth set of sources.

7. The apparatus of claim 4, wherein the fifth set of data dependency criteria comprise at least one of:
a target that is not subsequently read by a first memory access in a corresponding shader stage;
a seventh set of sources corresponding with a memory access of the first set of decomposable write memory accesses that are not used by a second memory access;
an eighth set of sources that are not used by the second memory access, wherein the seventh set of sources are transitively dependent on the eighth set of sources;
a ninth set of reads that are not self-referential; or
a tenth set of writes that are not self-referential.

8. The apparatus of claim 4, wherein, to calculate the second set of slicing criteria, the processor is configured to:
split an index set of a decomposable write memory access of the first set of decomposable write memory accesses based on the sixth set of predicates in response to an identification that the index set is associated with the sixth set of predicates.

9. The apparatus of claim 4, wherein, to calculate the second set of slicing criteria, the processor is configured to:
split an index set of a decomposable write memory access of the first set of decomposable write memory accesses in response to an identification that the index set is not associated with any predicates.

10. The apparatus of claim 9, wherein, to split the index set of the decomposable write memory access, the processor is configured to:
split the index set of the decomposable write memory access based on a resource size threshold.

11. The apparatus of claim 1, wherein, to output the indicator of the generated plurality of representation slices, the processor is configured to:
output the indicator of the generated plurality of representation slices to a compiler.

12. The apparatus of claim 1, wherein, to output the indicator of the generated plurality of representation slices, the processor is configured to:
schedule each program slice of the generated plurality of representation slices for asynchronous launch relative to other representation slices of the generated plurality of representation slices.

13. The apparatus of claim 12, wherein, to output the indicator of the generated plurality of representation slices, the processor is further configured to:
calculate a cost for an execution of the generated plurality of representation slices, wherein, to schedule each program slice of the generated plurality of representation slices, the processor is configured to schedule each program slice of the generated plurality of representation slices in response to the calculated cost being greater than or equal to a threshold value.

14. The apparatus of claim 1, wherein, to output the indicator of the generated plurality of representation slices, the processor is further configured to:
calculate a cost for an execution of the generated plurality of representation slices; and
output a second indicator of the calculated cost for the execution of the generated plurality of representation slices.

15. A method of graphics processing, comprising:
obtaining a representation of source code;
identifying that the representation comprises a first set of decomposable write memory accesses;
calculating a second set of slicing criteria based on the identified first set of decomposable write memory accesses;
generating a plurality of representation slices based on the representation of the source code and the calculated second set of slicing criteria; and
outputting an indicator of the generated plurality of representation slices.

16. The method of claim 15, wherein identifying that the representation comprises the indicator of the first set of decomposable write memory accesses comprises at least one of:
identifying that each of the first set of decomposable write memory accesses satisfies a third set of type criteria;
identifying that each of the first set of decomposable write memory accesses satisfies a fourth set of control flow (CF) criteria;
identifying that each of the first set of decomposable write memory accesses satisfies a fifth set of data dependency criteria; or
identifying whether an index set of the first set of decomposable write memory accesses is associated with a sixth set of predicates.

17. The method of claim 16, wherein calculating the second set of slicing criteria comprises:
splitting an index set of a decomposable write memory access of the first set of decomposable write memory accesses based on the sixth set of predicates in response to an identification that the index set is associated with the sixth set of predicates.

18. The method of claim 16, wherein calculating the second set of slicing criteria comprises:
splitting an index set of a decomposable write memory access of the first set of decomposable write memory accesses in response to an identification that the index set is not associated with any predicates.

19. The method of claim 18, wherein splitting the index set of the decomposable write memory access comprises:
splitting the index set of the decomposable write memory access based on a resource size threshold.

20. A computer-readable medium storing computer executable code, the code when executed by a processor, causes the processor to:
obtain a representation of source code;
identify that the representation comprises a first set of decomposable write memory accesses;
calculate a second set of slicing criteria based on the identified first set of decomposable write memory accesses;
generate a plurality of representation slices based on the representation of the source code and the calculated second set of slicing criteria; and
output an indicator of the generated plurality of representation slices.
